(19) United States
(12) Patent Application Publication
(10) Pub. No.: US 2018/0144654 A1
(43) Pub. Date: May 24, 2018

(54) SYSTEMS AND METHODS FOR AUTOMATED GRADING OF GEOMETRIC SHAPE ASSESSMENTS

(71) Applicant: SparxTeq Inc, Orem, UT (US)

(72) Inventor: Dan Reed Olsen, JR., Orem, UT (US)

(21) Appl. No.: 15/700,066

(22) Filed: Sep. 8, 2017

Related U.S. Application Data
(60) Provisional application No. 62/425,713, filed on Nov. 23, 2016.

(51) Int. Cl. G09B 7/02; G06K 9/62; G06N 5/02

(52) U.S. Cl. CPC G09B 7/02; G06N 5/02; G06K 9/6215

(57) ABSTRACT

The present disclosure provides systems and methods relating to creating, administering, and evaluating assessments, such as quizzes and tests. According to various embodiments, assessors create challenge problems that can be answered by assessees through the creation and/or manipulation of geometric shapes. Assessors can evaluate and assign feedback objects to geometric shape answers created by the assessees. The geometric shape answer items can be graded via a grading subsystem in batches and/or through a rule-based system to increase the efficiency and consistency of the grading process.

### RELATED APPLICATIONS

This application claims priority to U.S. Provisional Patent Application No. 62/425,713, titled “AUTOMATED GRADING ASSISTANCE FOR GEOMETRIC SHAPE QUIZZES,” filed on Nov. 23, 2016, which application is hereby incorporated by reference in its entirety.

### TECHNICAL FIELD

This disclosure relates to systems and methods for quiz administration, grading, and feedback. Specifically, the disclosure includes a computer-implementable architecture for administering, grading, and providing feedback with respect to assessments based on geometric shapes.

### BRIEF DESCRIPTION OF THE DRAWINGS

FIG. 1A illustrates an example of a shape problem, according to one embodiment.

FIG. 1B illustrates an example of an answer to the shape problem shown in FIG. 1A, according to one embodiment.

FIG. 2A illustrates an example of a shape problem with moveable geometric shapes for creating answers, according to one embodiment.

FIG. 2B illustrates an example of correct answers to the shape problem shown in FIG. 2A, according to one embodiment.

FIG. 3A illustrates an example of a shape problem with modifiable shape elements for creating answers, according to one embodiment.

FIG. 3B illustrates an example of a correct answer to the shape problem shown in FIG. 3A, according to one embodiment.

FIG. 4A illustrates an example of a shape problem that requires an assessee to create a new graphical shape, according to one embodiment.

FIG. 4B illustrates a line segment created by an assessee as an answer to the shape problem in FIG. 4A, according to one embodiment.

FIG. 5 illustrates an example of pseudo-code for defining a rectangular shape, according to one embodiment.

FIG. 6 illustrates additional example shapes that could be used by assessors creating shape problems and/or by assessees answering shape problems, according to various embodiments.

FIG. 7 illustrates examples of three-dimensional shapes that could be used by assessors creating shape problems and/or by assessees answering shape problems, according to various embodiments.

FIG. 8 illustrates an opaque overlay of shape answers from multiple assessees in the form of digital ink strokes overlaid on a shape problem, according to one embodiment.

FIG. 9 illustrates partially transparent shape answers from multiple assessees in the form of digital ink strokes overlaid on a shape problem, according to one embodiment.

FIG. 10 illustrates partially transparent shape answers from multiple assessees in the form of modifiable shapes overlaid on a shape problem, according to one embodiment.

FIG. 11 illustrates partially transparent shape answers from multiple assessees in the form of moveable shapes overlaid on a shape problem, according to one embodiment.

FIG. 12 illustrates a sub-sampled overlay of shape answers from multiple assessees for assessment by an assessor, according to one embodiment.

FIG. 13 illustrates a group of shape answers from multiple assessees that can be batch-assessed by an assessor, according to one embodiment.

FIGS. 14A and 14B illustrate a shape rule creation by an assessor using rectangular shape predicates for batch-assessment, according to one embodiment.

FIG. 15 illustrates a table of example shapes predicates and associated relations for batch assessment, according to one embodiment.

FIG. 16 illustrates a functional block diagram of one embodiment of an assessment system to implement one or more embodiments and subsystems described herein.

### DETAILED DESCRIPTION

A basic component of education is the assessment of a student's learning. This is not only useful for assigning grades but also for diagnosing deficiencies and recommending ways to improve a particular student's learning and/or the collective learning of a group of students. Similarly, it is useful to assess the abilities, knowledge, reasoning, memorization, and/or other capabilities of students or other assessees in a variety of situations, including education, training, certification, licensing, applications, and the like. One of the most time-consuming and tedious duties of a teacher or other assessor is the grading of assessment activities.

Automatic or semiautomatic mechanisms for grading assessments and providing feedback to students may improve the educational process. The current trend toward massive open online courses (MOOCs) highlights the need for less labor-intensive assessment strategies. When a class contains thousands or even tens of thousands of students, a teacher cannot reasonably hand grade all of the assessments and/or provide meaningful feedback. As the student education process becomes more independent, there is a need for students and assessors to be able to administer additional assessments to identify where learning has not occurred. Without a teacher playing close attention, more assessments and/or improved feedback is needed to track student learning progress. With increased assessment comes an increased grading load that may overwhelm assessors and/or limit their ability to provide meaningful feedback.

The classic solution to automatic grading has been the multiple-choice question. These questions are very easy to grade by hand, and technology to support automatic grading of multiple choice tests has existed for decades. Many students have answered quizzes by coloring in bubbles on a sheet to be scanned by an automatic grading machine. Within a classroom context, “clickers” have been used. These devices allow students to express one of several choices to a question posed by an instructor during class. The instructor gets immediate feedback on how many students selected the various answers. In computer-based coursework such multiple-choice answers are indicated by radio button widgets that a student can select.

One limitation of multiple choice tests is that human knowledge is more complex than can be reasonably represented by a multiple-choice test. Students develop strategies for eliminating choices and guessing at answers without developing a real understanding or sense of the material. Trying to assess more sophisticated concepts can be difficult or impossible to accomplish with traditional multiple choice assessments. Some systems allow students to enter numbers that can be matched against correct answers. Others allow students to type words or short phrases and then provide various rules and schemes by which the instructor can define what a correct answer is. There is a continuing need for more sophisticated ways to pose assessment problems to students and associated approaches for automatically or semi-automatically grading their answers.

The present disclosure includes systems and methods relating to the administration, evaluation, and review of assessments, such as quizzes and tests. This disclosure describes, for example, assessments that utilize geometric shapes a basic form for assessee answers to a wide variety of challenge questions. The geometric shape answers, or simply “shape answers,” provided by assessees can be automatically or semi-automatically assessed by an assessor. In some embodiments, meaningful feedback can be automatically or semi-automatically provided by an assessor to the assessee with respect to one or more geometric shape answers.

According to various embodiments, a method for administering an assessment, such as a quiz or test, may include presenting a geometric shape problem, as described below. Various systems and methods described herein relate to the creation, administration, and evaluation of geometric shape problems. An assessment system for authoring, administering, and/or evaluating geometric shape problems may include an authoring subsystem that allows shape problems to be created. The assessment system may alternatively or additionally include an administration subsystem that allows assessees to create shape answers to shape problems created via an authoring subsystem. Assessees may provide shape answers by creating and/or manipulating geometric shapes in the context of the shape problem. A shape answer may include a single geometric item or a plurality of geometric items. Accordingly, the terms shape answer and shape answer item may be used interchangeably in some instances, even though a shape answer technically includes one or more shape answer items.

The assessment system may include a grading subsystem that allows assessors to express grading criteria. The grading subsystem may apply the grading criteria in a shape grading form to automatically or semi-automatically grade shape answers provided by the assessees. The grading criteria, for example, may indicate one or more correct shape answers for a specific problem. Grading criteria may define boundaries for correct shape answers, boundaries for partially correct answers, and/or boundaries for incorrect shape answers. For correct, partially correct, and incorrect shape answers, the grading criteria may further define feedback objects, such as points, scores, letter grades, written commentary, deductions, etc.

In some instances, the grading subsystem may automatically apply the grading criteria provided by the assessor to multiple assessee shape answers without any or with limited assessor input. A shape answer (from an assessee) may be tagged as “graded” when one or more feedback objects have been applied to the shape answer. A feedback subsystem or module may facilitate the association of feedback objects with geometric shape answer items formed (created or modified) by assessees.

In various embodiments, an assessment system may include all, some, or even just one of: the authoring subsystem, the administration subsystem, the grading subsystem, and the feedback subsystem. In some embodiments, disparate systems may each implement one of the authoring subsystem, the administration subsystem, the grading subsystem, and the feedback subsystem. In some embodiments, some of the subsystems may be implemented locally via hardware, software, and/or firmware and some of the subsystems may be implemented in a remote location (e.g., cloud-based user-controlled software or via a browser-based software-as-a-service (“SaaS”)).

Additional description of various embodiments and implementations of the various assessment subsystems are provided below. Each of the various embodiments of subsystems described herein may be implemented as stand-alone systems or used in combination with other features or characteristics of other embodiments of the same subsystem or of different subsystems.

As used herein, an assessor includes anyone engaged in the creation of materials, delivery of materials, or evaluation of materials or individuals. Examples of an assessor include, but are not limited to, an individual; a group of teachers, instructors, supervisors, trainers, certifiers, licensors, application evaluators, or admissions evaluators; and/or other individuals or agencies engaged in evaluating an ability or a knowledge of one or more assessees.

As used herein, an assessee includes anyone assessed via an assessment by an assessor. Examples of assessees include, but are not limited to, individuals; groups of students, trainees, instructees, supervised employees or supervised volunteers, those seeking licensure, those seeking admission, or applicants; and/or others engaged in demonstrating an ability or a knowledge to one or more assessors.

As used herein, text may include both image-based text and machine-encoded text. For example, text may include a sequence of data codes that represents the components of some written language. Such a sequence of data codes is capable of being rendered by an algorithm running on a computer so as to produce a human readable version of the source written language. Such data encodings include ASCII, ISO-latin and UNICODE, as well as other less popular representations of written language. Text may also refer to compressed forms of such data.

As used herein, a rendering includes the process of converting some data structure into an image that can be displayed to a human being. There are many possible such data structures including HTML, Scalar Vector Graphics (SVG), and PostScript, to name a few. Presenting and displaying can be performed via any of a wide variety of audio, visual, haptic, and/or other electronic delivery approaches, including, but not limited to electronic displays, speakers, electronic reader devices, electronic braille devices, cell phones, laptops, computers, projectors, personal electronic devices, and/or the like.

As used herein, a drawing includes a data structure that can be rendered into an image. For example, a drawing may include a data structure that includes a list of graphics primitives. Graphics primitives are geometric shapes such as lines, circles, ovals, polygons, curves, images, etc. The rendering process includes taking each geometric primitive and performing its drawing operation that converts that primitive into pixel changes in an image. There are many graphics packages that define sets of drawing instructions from which a drawing can be assembled. These include X-Windows, PDF, PostScript or Microsoft RDP. A drawing may also be represented as a data structure of display primitives from which the visual presentation of the drawing can be generated. Examples of this include Microsoft WPF, Java FX, VRML, OpenGL or HTML.

As used herein, a digital ink stroke constitutes one type of a geometric shape. Specifically, a digital ink stroke may simulate the mark that might be made on a piece of paper using a pen or pencil. Just as a mark by a pen or pencil is made relative to a sheet of paper, a digital ink stroke may be spatially defined relative to a challenge problem. A digital ink stroke may include a sequence of two-dimensional points that can be thought of as being connected by line segments to form a complete stroke.

Interactively, a digital ink stroke may be created by a start event, multiple move events and/or an end event. The start event might be a mouse press, pen press, finger touch to a surface or any other input event that is accompanied by a two-dimensional point that is the start of the stroke. The move events may be generated as long as the stroke is substantially continued and the two-dimensional point is changed. For example, this might be movement while a pen or finger stays in contact or a mouse button remains pressed. There may be many of these interactions that, together, form a digital ink stroke. One or more move events may add a point to the stroke. The end event includes any user action that indicates that points are to no longer be added to the stroke. This might be removing a pen or finger from a surface or releasing a mouse button.

Digital ink strokes can also be retrieved from images. There are a variety of image processing techniques that will extract a sequence of connected points from an image. These can be used as a digital ink stroke.

A digital ink stroke may be color independent where the color of the pixels is irrelevant. It may also be the case that a digital ink stroke has a color which is shared by all of the points in the stroke and their connecting line segments. The color of a digital ink stroke may also be transparent or have some other transfer function defined so that when the stroke is drawn over other image material, the other image partially shows through. Digital ink strokes may be referred to herein interchangeably as simply “strokes.”

Digital ink strokes may be combined and connected to form two-dimensional shapes, such as polygons, circles, ovals, curves, and/or combinations thereof. In some embodiment, digital ink strokes may be combined and connected to form three-dimensional spatial shapes, three-dimensional shapes that comprise two-dimensional shapes extending through time (such as through various frames of a video clip, audio clip, sequence of images, etc.), and/or four-dimensional shapes that comprise three-dimensional shapes extending through time (again, such as through various frames of a video clip, etc.).

As used herein, video includes a data representation of a sequence of images that can be presented to a human being at a rate sufficient to be perceived as continuous motion. This also includes data representations capable of presenting continuous motion whether the content of that data representation actually contains continuous motion, or not. Video may optionally include audio that is synchronized with the image sequence.

As used herein, audio includes any data representation of sound. This would include any form of data from which an algorithm running on an appropriately configured computer could produce sounds audible to human beings.

Digital media includes any combination of text, drawing, image, digital ink stroke, audio, and/or video. In some embodiments, a digital media creation tool is embodied as software that allows a user to create one or more types of digital media. The creation of digital media comprises interactive manipulations by the user through one or more acquisition devices such as scanners, microphones or cameras, and/or combination thereof. In some embodiments, digital media includes references to external digital media, such as URLs.

As used herein, a click includes a brief indicator of a two-dimensional point using some interactive input device. Examples of a click include the press and release of a computer mouse button, a tap on a touch screen with the finger, or a tap of a stylus on a tablet or other personal computing device. The click may be a single two-dimensional point that is indicated and for which the expression of the point is brief.

As used herein, a drag includes an indication of the movement of some object on a display screen. In some embodiments, a drag is initiated by the indication of a two-dimensional start point. This start point selects the displayed object to be moved. In a subsequent movement phase, the user identifies one or a series of new two-dimensional points to which the object is successively moved. After one or more “movement points” there is a final drop point that indicates the two-dimensional point where the object should be dropped. A similar movement sequence can be used to drag an object through a three-dimensional space.

Examples of dragging include: pressing a mouse button to start the drag, moving the mouse while holding down that button and then releasing that mouse button at the drop point. A stylus press, move and release can be used as a drag. A finger touch, hold down while moving and lift can be used as a drag.

Embodiments of an assessment system and/or component parts, associated systems, and subsystems may include various steps, which may be embodied in machine-executable instructions to be executed by a computer system. A computer system may be embodied as a general-purpose or special-purpose computer (or other electronic devices). The computer system may include hardware components that include specific logic for performing the steps or may include a combination of hardware, software, and/or firmware.

Embodiments may also be provided as a computer program product including a computer-readable medium having stored thereon instructions that may be used to program a computer system or other electronic device to perform the processes described herein. The computer-readable medium may include, but is not limited to: hard drives, floppy diskettes, optical disks, CD-ROMs, DVD-ROMs, ROMs, RAMs, EPROMs, EEPROMs, magnetic or optical cards, solid-state memory devices, or other types of media/computer-readable media suitable for storing electronic instructions.

Computer systems and the computers in a computer system may be connected via a network. Suitable networks for configuration and/or use as described herein include one or more local area networks, wide area networks, metropolitan area networks, and/or Internet or IP networks, such as the World Wide Web, a private Internet, a secure Internet, a value-added network, a virtual private network, an extranet, an intranet, or even stand-alone machines which communicate with other machines by physical transport of media. In particular, a suitable network may be formed from parts or entireties of two or more other networks, including networks using disparate hardware and network communication technologies.

One suitable network includes a server and several clients; other suitable networks may contain other combinations of servers, clients, and/or peer-to-peer nodes, and a given computer system may function both as a client and as a server. Each network includes at least two computers or computer systems, such as the server and/or clients. A computer system may include a workstation, laptop computer, disconnectable mobile computer, server, mainframe, cluster, so-called “network computer” or “thin client,” tablet, smart phone, personal digital assistant or other hand-held computing device, “smart” consumer electronics device or appliance, medical device, or a combination thereof.

Suitable networks may include communications or networking software, such as the software available from Novell, Microsoft, Artisoft, and other vendors, and may operate using TCP/IP, SPX, IPX, and other protocols over twisted pair, coaxial, or optical fiber cables, telephone lines, radio waves, satellites, microwave relays, modulated AC power lines, physical media transfer, and/or other data transmission “wires” known to those of skill in the art. The network may encompass smaller networks and/or be connectable to other networks through a gateway or similar mechanism.

Each computer system includes one or more processor and/or memory; computer systems may also include various input devices and/or output devices. The processor may include a general-purpose device, such as an Intel®, AMD®, or other “off-the-shelf” microprocessor. The processor may include a special purpose processing device, such as an ASIC, SoC, SiP, FPGA, PAL, PLA, FPLA, PLD, or other customized or programmable device. The memory may include static RAM, dynamic RAM, flash memory, one or more flip-flops, ROM, CD-ROM, disk, tape, magnetic, optical, or other computer storage medium. The input device(s) may include a keyboard, mouse, touch screen, light pen, tablet, microphone, sensor, or other hardware with accompanying firmware and/or software. The output device(s) may include a monitor or other display, printer, speech or text synthesizer, switch, signal line, or other hardware with accompanying firmware and/or software.

The computer systems may be capable of using a floppy drive, tape drive, optical drive, magneto-optical drive, or other means to read a storage medium. A suitable storage medium includes a magnetic, optical, or other computer-readable storage device having a specific physical configuration. Suitable storage devices include floppy disks, hard disks, tapes, CD-ROMs, DVDs, PROMs, RAM, flash memory, and other computer system storage devices. The physical configuration represents data and instructions which cause the computer system to operate in a specific and predefined manner as described herein.

Suitable software to assist in implementing the invention is readily provided by those of skill in the pertinent art(s) using the teachings presented here and programming languages and tools, such as Java, Pascal, C++, C, database languages, APIs, SDKs, assembly, firmware, microcode, and/or other languages and tools. Suitable signal formats may be embodied in analog or digital form, with or without error detection and/or correction bits, packet headers, network addresses in a specific format, and/or other supporting data readily provided by those of skill in the pertinent art(s).

Several aspects of the embodiments described will be illustrated as software modules or components. As used herein, a software module or component may include any type of computer instruction or computer-executable code located within a memory device. A software module may, for instance, include one or more physical or logical blocks of computer instructions, which may be organized as a routine, program, object, component, data structure, class, etc., that perform one or more tasks or implement particular data types. It is appreciated that a software module may be implemented in hardware and/or firmware instead of or in addition to software. One or more of the functional modules described herein may be separated into sub-modules and/or combined into a single or smaller number of modules.

In certain embodiments, a particular software module may include disparate instructions stored in different locations of a memory device, different memory devices, or different computers, which together implement the described functionality of the module. Indeed, a module may include a single instruction or many instructions, and may be distributed over several different code segments, among different programs, and across several memory devices. Some embodiments may be practiced in a distributed computing environment where tasks are performed by a remote processing device linked through a communications network. In a distributed computing environment, software modules may be located in local and/or remote memory storage devices. In addition, data being tied or rendered together in a database record may be resident in the same memory device, or across several memory devices, and may be linked together in fields of a record in a database across a network.

Much of the infrastructure that can be used according to the present invention is already available, such as general purpose computers, computer programming tools and techniques, computer networks and networking technologies, digital storage media, authentication, access control, and other security tools and techniques provided by public keys, encryption, firewalls, and/or other means.

The embodiments of the disclosure are described below with reference to the drawings, wherein like parts are designated by like numerals throughout. The components of the disclosed embodiments, as generally described and illustrated in the figures herein, could be arranged and designed in a wide variety of different configurations. Furthermore, the features, structures, and operations associated with one embodiment may be applicable to or combined with the features, structures, or operations described in conjunction with another embodiment. In other instances, well-known structures, materials, or operations are not shown or described in detail to avoid obscuring aspects of this disclosure.

Thus, the following detailed description of the embodiments of the systems and methods of the disclosure is not intended to limit the scope of the disclosure, as claimed, but is merely representative of possible embodiments. In addition, the steps of a method do not necessarily need to be executed in any specific order, or even sequentially, nor do the steps or sequences of steps need to be executed only once or even in the same order in subsequent repetitions. Finally, as used herein, the term “set” may include a non-zero quantity of items, including a single item.

As described herein, an assessment system may include an authoring subsystem, an administration subsystem, a grading subsystem, and/or a feedback subsystem. According to various embodiments, an authoring subsystem may be embodied as hardware, firmware, software, or a combination thereof. The authorizing subsystem may be used by an assessor to create a shape problem. The shape problem, as described above, may be a data structure that includes sufficient information to visually and/or aurally present a problem to an assessee.

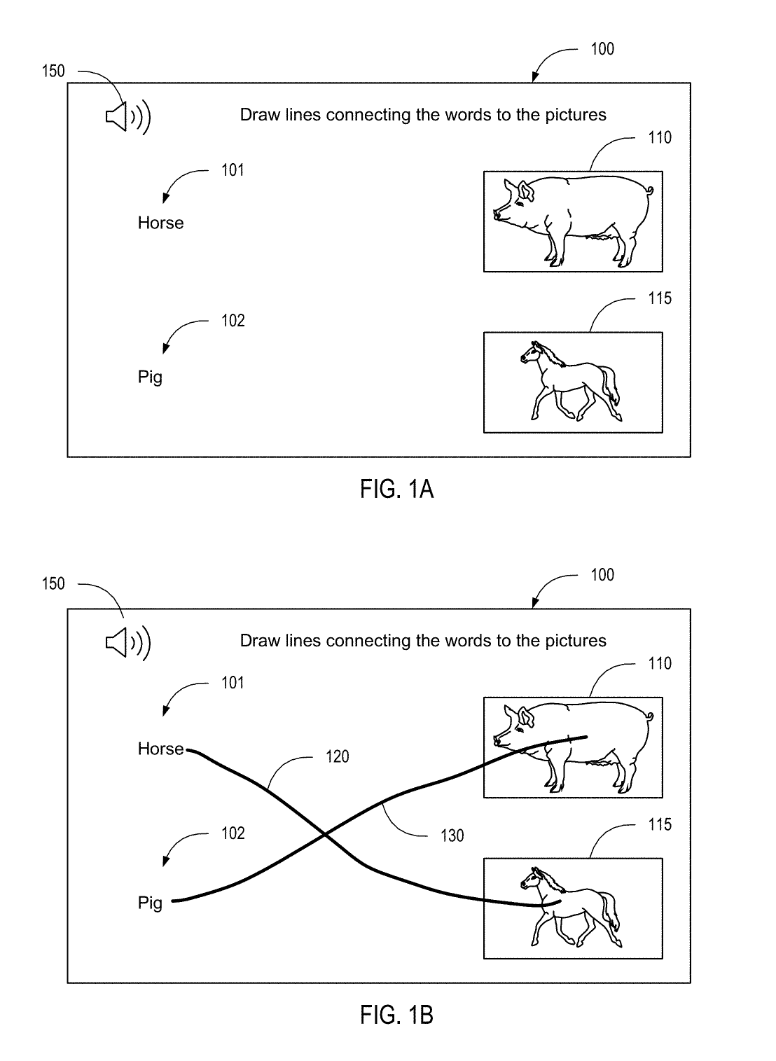

FIG. 1A illustrates an example of a shape problem 100, that includes instructions to “draw lines connecting the words with the pictures.” In some embodiments, the assessee may select a speaker icon 150 to have the instructions spoken aloud (e.g., via a computer automated voice and/or a pre-recorded audio message). In some embodiments, the instructions may be automatically spoken aloud when the shape problem 100 is initially presented and/or periodically while the shape problem 100 is being displayed to an assessee.

The example shape problem 100 in FIG. 1A includes an image of a pig 110 and an image of a horse 115. Displayed words “Pig” 102 and “Horse” 101 may be part of the shape problem 100. The illustrated shape problem 100 includes a fixed representation of the words 101 and 102 and the images 110 and 115. The Assessee may draw lines via an input device (e.g., a finger or stylus via a touch screen, a mouse, joystick, etc.) connecting one of the words 101 and 102 with one of the images 110 and 115.

The illustrated embodiment is simplified for this description. It is appreciated that a shape problem 100 could include a video, documents through which an assessee can scroll, a moveable three-dimensional model, a sequence of images, a graph, and/or the like. Assessees may be able to zoom in and out for specific problems and/or scroll through portions of them. An assessor can include a wide variety of content and questions in a shape problem. Regardless of the question(s) presented in the shape problem, an assessee can answer a shape problem by interactively creating and/or manipulating one or more geometric shapes.

FIG. 1B illustrates geometric shapes 120 and 130 created by an assessee as answers to the shape problem 100. In the illustrated embodiment, the geometric shapes 120 and 130 created by the assessee comprise digital ink strokes (e.g., lines created by a finger, stylus, mouse, etc.) connecting each of the words 101 and 102 with the pictures 110 and 115. In some embodiments, the geometric shapes may be color-coded. For example, a first stroke may be a first color, a second stroke may be a second color, and so on. Using a known order of colors, a human assessor and/or assessor system can better understand and/or analyze the assessee's thought process. In some embodiments, the color-coded answer may be color-coded when displayed to the assessor, but all the same color (e.g., black) when displayed to the assessee during creation.

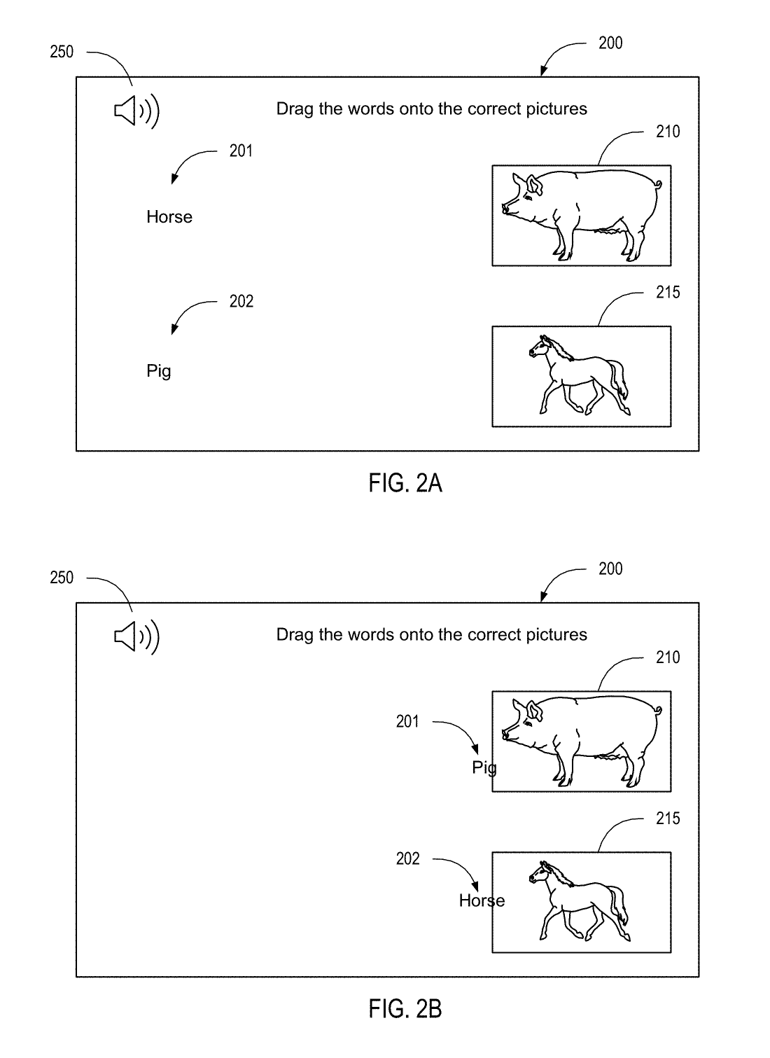

FIG. 2A illustrates an example of a shape problem 200 with moveable geometric shapes 201 and 202 for creating answers to an expressed problem. In the illustrated embodiment, the moveable geometric shapes 201 and 202 are words describing the images 210 and 215 of the pig and horse, respectively. Again, an audio button 250 may allow for the instructions to be read aloud or repeated if they have already been read aloud. In some embodiments, the audio button 250 may include options (e.g., via a setting menu, drop down menu, or the like) for speed, voice gender, language, accent, etc.

In other embodiments, the movable geometric shapes could be the images that are intended to be moved to the location of the word. In still other embodiments, either one of them may be moved to the location of the other. In the illustrated embodiment, the relationship between the movable geometric shapes 201 and 202 have a one-to-one (1:1) correspondence with the images 201 and 215. In other embodiments, the relationship may be many-to-one (X:1) or one-to-many (1:X).

FIG. 2B illustrates an example of correct answers to the shape problem 200 shown in FIG. 2A, according to one embodiment. In the illustrated embodiment, an assessee has moved the geometric shape 201 “Pig” proximate or on top of the image 210 of the pig and the geometric shape 202 “Horse” proximate or overlapping the image 215 of the horse.

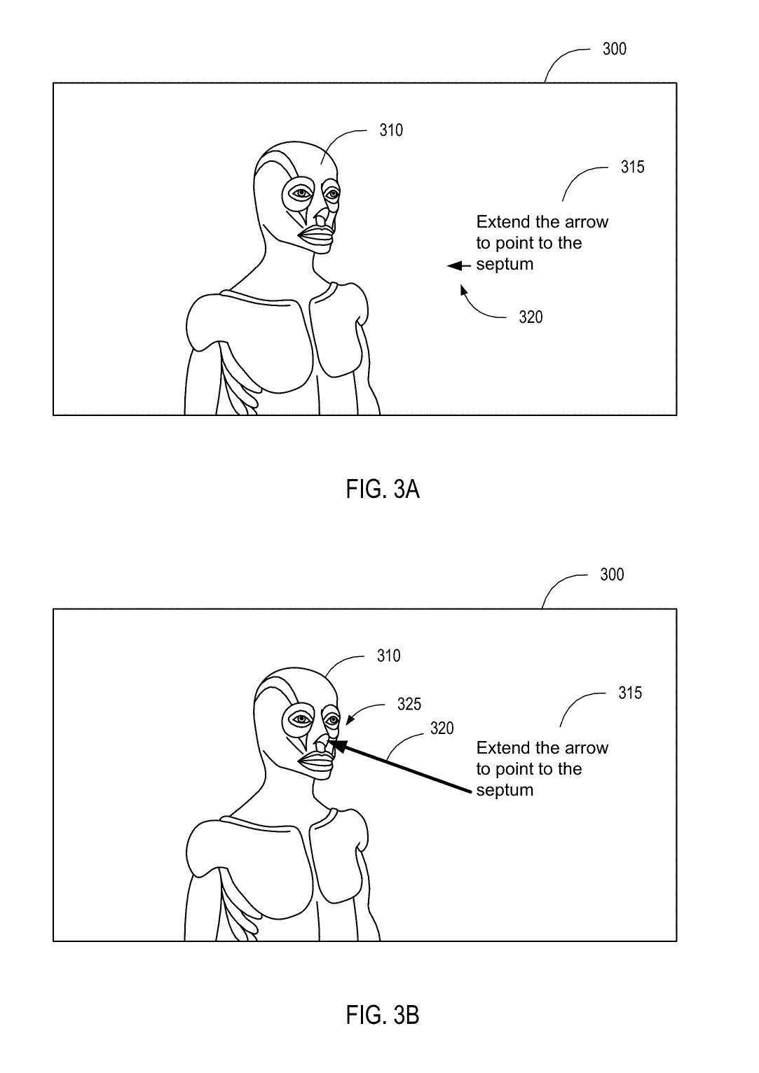

FIG. 3A illustrates an example of a shape problem 300 with a modifiable geometric shape 320 for creating answers, according to one embodiment. As illustrated, a fixed image of a human body 310 is shown on the left half of the shape problem 300. Instructions 315 instruct an assessee to “extend the arrow to point to the septum.” An assessee may “grab” the modifiable geometric shape (in this instance, the arrow 320) and extend it to the septum 325 (see FIG. 3B) of the human body 310.

FIG. 3B illustrates an example of a correct answer to the shape problem 300 shown in FIG. 3A, according to one embodiment. As illustrated, an assessee has extended the arrow of the geometric shape 320 to the septum 325 of the human body 310.

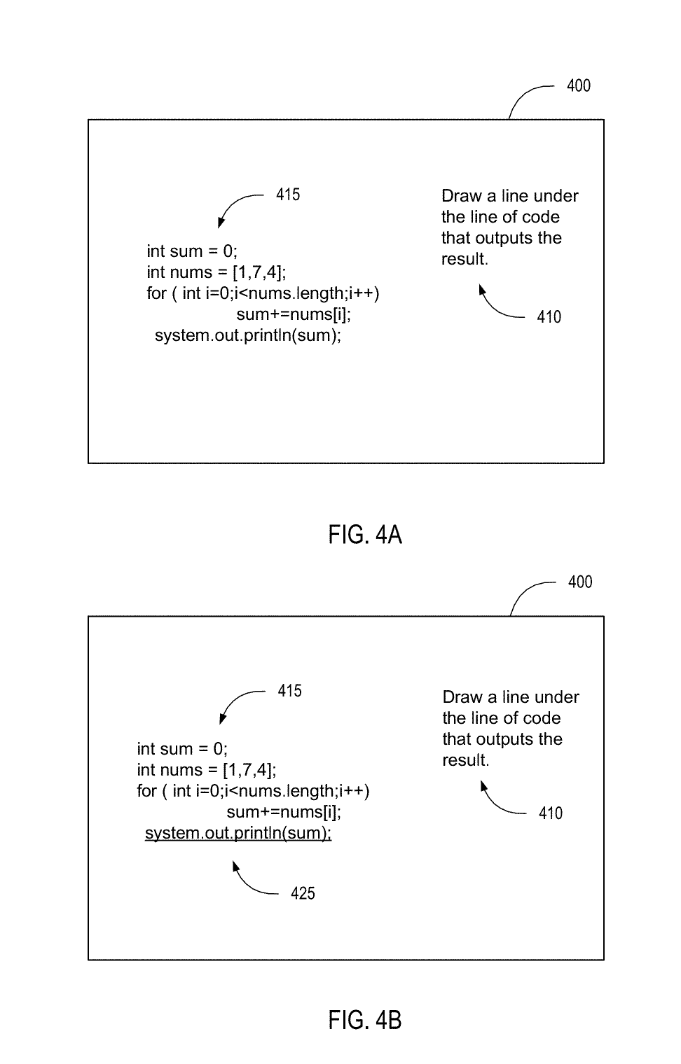

FIG. 4A illustrates an example of a shape problem 400 that requests, via instructions 410, that an assessee create a new geometric shape, according to one embodiment. In the illustrated embodiment, the instructions 410 request that the assessee “draw a line under the line of code that outputs the result.” In similar embodiments, the request may be to create a highlight geometric shape, or a circle geometric shape, or a rectangular geometric shape, etc. to identify a specific portion of the fixed or static portion of the question, i.e., the code segment 415.

The code segment 415 may be small enough to fit on a single screen, may be a scrollable, longer segment of code, may be clickable to open in a separate window, and/or may be audibly read to the assessee. It is appreciated that the creation of a new geometric shape may be associated with a wide variety of other challenge problems that are different than code segments.

FIG. 4B illustrates a line segment 425 created by an assessee as an answer to the shape problem in FIG. 4A, according to one embodiment. The geometric shape created by the assessee, line segment 425, can be represented as a data structure comprising, for example, two endpoints of a line. In other embodiments, it may be defined as a plurality of vertices defining a polygon, a plurality of points defining a line have various straight or curved segments, etc.

The embodiments above are provided by way of example only. An authoring subsystem may allow an assessor to create any of a wide variety of challenge questions that can be answered by an assessee creating or modifying any combination of geometric shape answers, as described herein. Once a shape problem is created, an administration subsystem may be used to administer the test to one or more assessees. In some embodiments, the administration subsystem may administer an identical assessment to each of a plurality of assessees.

In another embodiment, an assessor may create a unique assessment for each assessee. In another embodiment, the assessor may create a single assessment and the administration subsystem may rearrange the challenge problems automatically to at least partially customize the test for each assessee.

The administration subsystem may be embodied as hardware, firmware, software, and/or a combination thereof to allow assessees to express answer to shape problems. The administration subsystem may convert a plurality of shape problem representations into one or more presentations that facilitate assessees in expressing answer to the shape problems. The administration subsystem may present the challenge shape problem via an electronic display and/or audio output device.

One or more shape problems may be created via the authoring system, as described above. The administration subsystem may render the one or more shape problems that is created by an assessor via an authoring system for presentation to assessees. The administration subsystem may render the one or more shape problems using any of a wide variety approaches and algorithms, including adaptations of those described in “Computer Graphics Principles and Practice” by Foley, J., van Dam, A., Feiner, S. and Hughes, J. published by Addison-Wesley, 1990 (hereinafter “Foley”), which is hereby incorporated by reference in its entirety.

The administration subsystem may allow assessees to use one or more input devices (e.g., a touch screen, a mouse, a stylus, eye tracking, or the like) to create and/or modify one or more geometric shapes as a shape answer item(s) in response to a challenge shape problem(s). A shape answer item may comprise a data structure that includes data defining the geometry of one or more shapes. An assessee may interactively create and/or modify one or more shapes to form a shape answer item. A shape answer to a challenge shape problem may include one or more shape answer items. Examples of data structures defining geometric shapes can be found in Foley and in “Building Interactive Systems” by Olsen, D. published by Cengage, 2010 (hereinafter “Olsen”), which is hereby incorporated by reference in its entirety.

A shape answer item, and its corresponding data structure, may include information necessary to define the geometry of a shape created or modified by an assessee relative to a challenge shape problem. In some instances, a shape answer item may include all the information necessary to define the geometry of shape created by an assessee. In some embodiments, a shape answer item may only provide sufficient information to define modifications made to a modifiable shape originally presented to the assessee for manipulation.

For example, in FIG. 2B, the answer item need only contain the new location of the word “Pig” because the problem itself contains the rest of the geometric information about that word. In FIG. 3B, only one end-point of the arrow needs to be in the shape answer item because the other end-point is given in the problem specification. A shape problem administration subsystem may transmit and/or record assessee shape answer items and/or shape answers as digital data. For example, the administration subsystem may store an assessee's answer item using a non-transitory storage medium. Such storage may include answer item representations as well as reference to personal identifying information of the assessee, unless the assessment is intended to be anonymous.

The authoring subsystem and/or the administration subsystem allow assessors and assessees, respectively, to create challenge shape problems and shape answers, respectively, that are based at least in part on the creation and/or manipulation of geometric shapes.

A geometric shape may be a data structure comprising a subset of points in an N-dimensional real number space, wherein N is an integer greater than or equal to 1. A set or “class” of geometric shapes that can be used within the assessment system may be defined by a class membership function C. The class membership function C may receive a geometric point A and a set of parameters P that define a shape and return “true” if the point A lies within the set of points P that defines the shape. For example, a rectangle shape in a 2-dimensionals space can be represented by parameters: left, right, top, bottom.

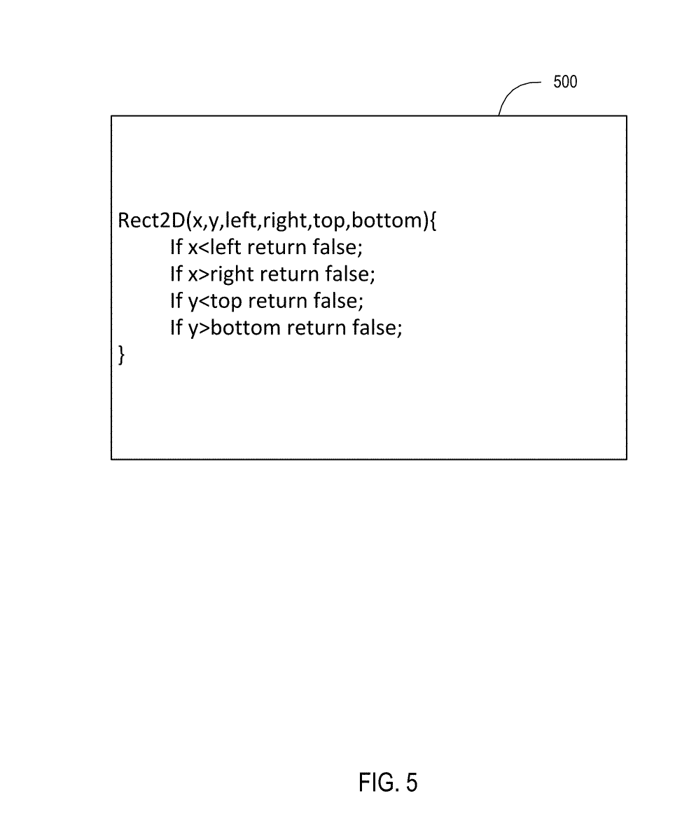

FIG. 5 illustrates an example of pseudo-code 500 for defining a rectangular shape, according to one embodiment. As illustrated, a “Rect2D” function receives parameters x, y, left, right, top, and bottom. The parameters x and y specify a point in a two-dimensional space and the function compares the points x and y to determine if it is within a rectangle in the two-dimensional space defined by a left edge, right edge, top edge, and a bottom edge.

In other embodiments, the rectangle may be defined by coordinate points in the two-dimensional space and the parameters x and y may be used to determine if a point defined by coordinates x and y is within the rectangle defined by four vertices in the two-dimensional space. A wide variety of comparison functions for any number of shapes in two-, three-, and multi-dimensional spaces are possible, as will be appreciated by those of skill in the art.

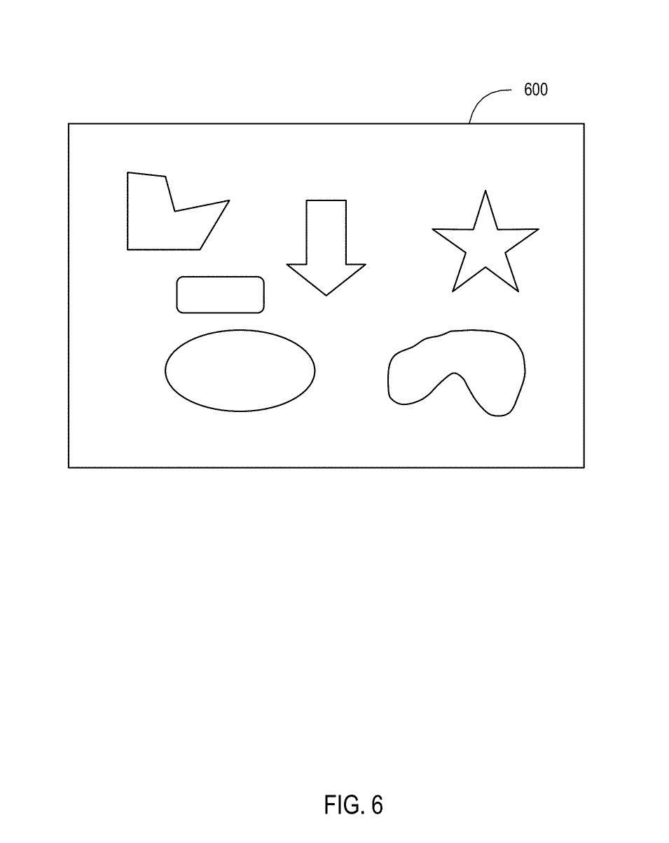

FIG. 6 illustrates additional example geometric shapes 600 that could be used by assessors creating shape problems and/or by assessees answering shape problems, according to various embodiments.

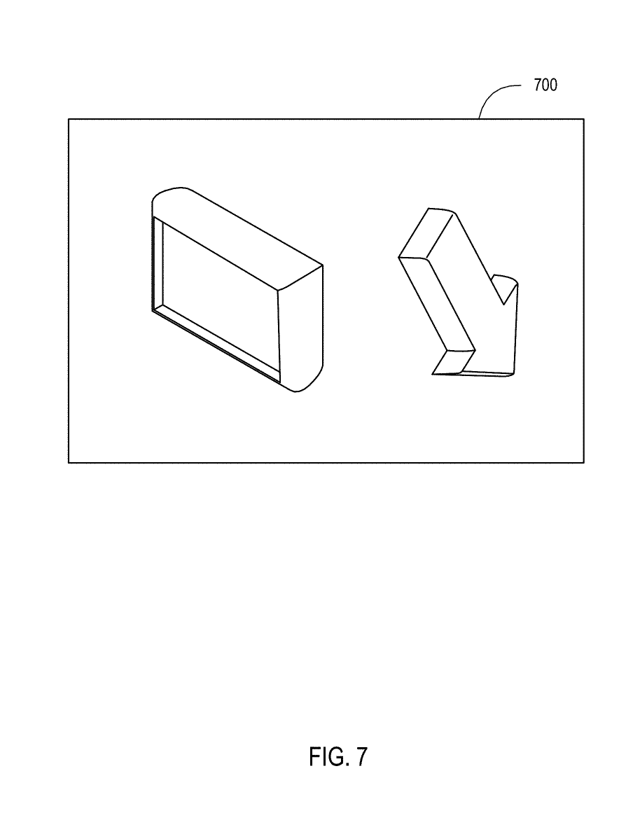

FIG. 7 illustrates example three-dimensional shapes 700 that can be used by assessors creating shape problems and/or by assessees answering shape problems, according to various embodiments.

Geometric shapes may be any size or shape and may be defined as one-dimensional objects (e.g., a point comprising one or a few pixels), two-dimensional objects, three-dimensional objects, or multi-dimensional objects (e.g., objects defined across a sequence of images or video frames). Two-dimensional objects and three-dimensional objects, and implementations of the same in hardware, firmware, software, and combinations thereof are described in Foley and Olsen.

Further examples of one dimensional shapes include start and/or end points on a time line with the single dimension being time. Further examples of three-dimensional shapes include two-dimensional shapes (such as an ellipse) imposed on a frame of a video and then extended forward for a certain number of seconds in time (where time is the third dimension). Further examples of four-dimensional shapes include three-dimensional shapes swept through a segment of time (where time is the fourth dimension).

In some embodiments, a shape, S, may be referred to and described as an entity. Accordingly, a class, S.class, may be a class membership function that defines shape S and includes S.params as the parameters of the shape. To test a point P for membership in shape S the system can compute S.class(P,S.params). S(P) may be used as a simplification of the notation equivalent to S.class(P,S.params).

In some embodiments, two shapes that look alike to a human may have very different geometric descriptions from a computer's perspective. For example, in FIG. 1B the digital ink 120 stroke from the word 101 “Horse” to the picture 115 of the horse would look to a human as identical or at least very similar to a digital ink stroke starting at the picture 115 of the horse and ending on the word 101 “Horse”. In terms of their data representation, these strokes may be very different.

Similarly, enumerating the points in clockwise order of a polygon creates a very different representation than when the points of the polygon are enumerated in a counter-clockwise order. A data representation of a polygon may have identical points, but use different starting points, ending points, order of points etc.

One approach for dealing with comparison problems relating to order, start points, and end points is normalization. Normalization is a process of converting a shape description to a standardized form that represents an identical or similar shape. For example, a digital ink stroke has a start and an end point. If the end point is closer to the origin (0,0) than the start point, then we reverse the order of the points. This normalization process creates an identical looking ink stroke that is more likely to match similar ink strokes that have also been normalized. As another example, the system may normalize a polygon by selecting a point closest to the origin as the starting point and then enumerating the vertices in a clockwise direction.

As described above, in some embodiments the system may use a class function. In other embodiments, an approximation or shortcut implementation may be used in addition to or instead of class functions. For example, a class of shapes describing two-dimensional line segments. A membership function Line2D(x,y,x1,y1,x2,y2) may define a set of points that lie on a straight line segment between two points (x1,y1) and x2,y2). This definition may present some complication for interactive systems that compare an assessee-created line with a model answer line because the line segments are infinitely thin. One solution is to add a thickness parameter and redefine the function to include any point whose distance to the closest point on the line segment is less than or equal to half of the thickness parameter. Such an approach provides an otherwise infinitely thin line segment an area.

One function of the system is to ultimately compare assessee shape answers with a “correct” shape answers to an assessor-created challenge shape problem. Accordingly, a comparison of geometric shapes may include defining relationships between shapes rather than specific point membership in a space as would be defined in a class membership function. For example, it may be desirable to determine if two line segments “touch” each other and/or the number of times two lines touch or cross each other. A class membership function may be used for comparison.

However, in some embodiments, it may be more efficient to measure a closest distance D between the two line segments (R and S) and identify them as “touching” if the distance is less than one half of: a thickness of line segment R added to a thickness of line segment S, expressible as: D<(R.thickness+S.thickness)/2. The class membership function may additionally or alternatively be used to define the two line segments as geometric shapes for comparison.

Assessor-created model shape answer and assessee created shape answers may be compared to one another for grading or other assessment purposes. It is expected that correct assessee shape answers may not be identical to the assessor-created model shape answers. Accordingly, the system may compare the geometric shapes for similarity. Two shapes (R and S) are identical if the set of points that belong to each of them are identical. Likewise, if R and S use the same class membership function C then they are identical shapes if their parameter values are identical.

Shapes R and S are also identical if for all points (x,y) it is true that R.c(x,y,R) equals S.c(x,y,S). Accordingly, shapes R and S may have different classification functions and still be identical. For example, if R is a rectangle and S is defined by the intersection of two other rectangles. They could be identical shapes even if their classification functions and parameters are different.

Alternatively or additionally, a system may be configured to determine similarity. According to one embodiment, a similarity function receives two shapes—sim(R,S)—and returns a real number. Each similarity function may be defined to include an identity value such that if shapes R and S are identical shapes then sim(R,S)=identity value. In many, but not all, instances, the identity value for a similarity function is one (1). Given three shapes R, S and T, if absoluteValue(sim(R,S)−identity value)>absoluteValue(sim(R,T)−identity value) then shape R is more similar to shape S than it is to shape T.

The system may optionally use a distance function to partially or fully determine similarity. For example, if shapes R and S have the same shape class function and all of their parameters are real numbers, then one possible measure of similarity is the distance between the parameter vectors for R and S. There are a variety of distance metrics that have been defined including Euclidean, Manhattan, Mahalanobis and many others, as described in “Pattern Classification” by Duda, R., Hart, P. and Stork, D. published by John Wiley and Sons, 2001 (hereinafter “Duda”), which is hereby incorporated by reference in its entirety. Each of the distance functions may be used in different implementations to leverage the strengths of the different distance functions, as described in Duda. When a feature distance is used for a similarity function, the identity value may be zero.

In various embodiments, similarity and distance measures can be used interchangeably or in combination. A similarity measure increases as two shapes are closer to identical. A distance measure decreases with similarity, such that identical shapes have a distance of zero. Given a distance measure D(a,b) such that MaxD is the greatest possible distance between two shapes a similarity measure can be expressed as:

S(a,b)=MaxD−D(a,b) Equation 1

Given a similarity measure S(a,b) with a maximum similarity of MaxS, a distance can be expressed as:

D(a,b)=MaxS−S(a,b) Equation 2

The expressions in Equation 1 and Equation 2 allow the system to use similarity measures and/or distance measures, depending on the specific embodiment, to determine a similarity between two geometric shapes.

In some embodiments, for a given class of shapes the system may compute the volume of a shape (R.volume) which is a measure of the size of the shape. For two-dimensional shapes, an area may be calculated instead of a volume. The system may be configured to calculate a shape intersect(R,S), which is defined by the set of all points that belong to both R and S. A similarity function may be expressed as:

$$Equation 3$$

$$sim ( R , S ) = [ \frac{volume ( intersect ( R , S ) )}{volume ( R )} + \frac{volume ( intersect ( R , S ) )}{volume ( S )} ]$$

In Equation 3, the identity value may be 2, where the volume of the intersection is the same size as the volume of each of the shapes. For many shapes, such as circles, rectangles, polygons, etc., known mathematical formulas may be used to compute the volume of the shape. For more complex shapes, such as irregular shapes, the system may approximate the volume by random sampling. To calculate a volume of a shape S, that is known to be contained within a shape U, the system may randomly generate a set of points Q that are uniformly distributed within shape U. The system may then test all points Qi with the function S.class(Qi,S.params) and count the number of times the shape function is true. The volume of S is then approximately U.volume( )*NumberOfTrueQi/TotalNumberOfQi.

The system may define a set of relations between shapes to facilitate grading (or other assessment). A shape relation may be defined by a boolean function R that can compare two shapes D and E. If R(D,E) is true, then the relation R holds between the two shapes, D and E. We can also express this relation using object-oriented notation such as D.R(E) which is identical to R(D,E). In the object-oriented notation, the relation R is a method defined on the shape D.

For example, the relation Touches(D,E) is true if shape D touches shape E. More formally Touches(D,E) is true if there exists at least one point P such that D(P) and E(P) are both true. Touches is an example of a shape relation that may be used for assessment purposes when comparing assessee-created shape answers with model shape answers (e.g., those created by assessors or other interested parties). Other examples of useful relation identities include:
i. Contains(D,E)—if for any point P such that D(P) then E(P) also is true. In short all points in D are also in E.
ii. Above(D,E)—for all points P1 such that D(P1) is true and for all points P2 such that E(P2) is true then if P1.y<=P2.y the relation Above(D,E) holds. This assumes the Y coordinate pointing down as on most computer screens.
iii. Near(D,E)—there exists two points P1 and P2 such that D(P1) and E(P2) and distance(P1,P2)<T where T is some fixed threshold value.
iv. Disjoint(D,E)—there does not exist any point P such that D(P) and E(P).

Some shapes may have characteristic points such as L.start or L.end (e.g., when L is a line segment), C.center (e.g., when C is a circle), or R.topLeft (e.g., when R is a rectangle). Such characteristic points may be used to define another set of shape relations that are based on the characteristic points. Examples of such relations are:
i. ContainsStart(S,L)—if S(L.start) is true.
ii. ContainsCenter(S,C)—if S(C.center) is true.

Shape relation functions may be defined in the negative as well. For example: ˜Contains(D,E) is true only when Contains(D,E) is not true.

As discussed above, an assessment system may include a grading subsystem. In some embodiments, a grading subsystem functions in combination with and/or is integral with a feedback subsystem. In other embodiments, a grading subsystem may be functionally distinct from a feedback subsystem. The grading subsystem may be embodied as hardware, firmware, software, and/or a combination thereof. The grading subsystem may be configured to automatically grade assessments and/or may be interactively used by an assessor to grade assessments and/or provide feedback (as described in greater detail below).

As previously described, an assessee may create and/or modify a geometric shape to form an assessee shape answer. The assessee shape answer may include one or more shape answer items, as discussed above. The grading system facilitates the grading process by allowing an assessor to (automatically or semi-automatically) assign one or more feedback objects to each shape answer item or shape answer.

An assessor may manually grade each assessment manually on printed assessments; however, such an endeavor may be very time consuming and prone to human errors and inconsistencies in grade and feedback assignments. The Assessor may manually grade electronic versions, but such an endeavor would merely be the electronic equivalent of the manual grading process.

In various embodiments, an assessor may use the grading subsystem to perform this grading process by hand. However, the grading subsystem may implement one or more of the algorithms and grading approaches described below to expedite the grading process, some of which do not even require the assessor to individually review each assessee shape answer.

An assessor may assign one or more feedback objects to an assessee's shape answer. A feedback object may be embodied as a data structure that can be rendered into visual and/or aural form to inform an assessee about the implications and/or correctness of their answer. Some assessments may have objective right/wrong answers, in which a feedback object may include, but is not limited to, a letter or numerical grade. Examples of objective tests include some math, science, and history tests. Other assessments may not necessarily have right/wrong answers, but rather provide useful information to the assessor and/or assessee based on subjective answers. Examples of subjective tests include personality tests, relationship compatibility tests, job finding tests, skill-based tests, and the like.

A feedback object may consist simply of a letter grade or numerical grade. In other embodiments, a feedback object may alternatively or additionally include text, html, video, images, audio, and/or hyperlinks to additional information. When grading an assessee shape answer, the grading subsystem may associate one or more feedback objects with the assessee shape answer. This association between an assessee shape answer and a feedback object can take any of a variety of data forms such as a pointer, a key, an index or a name.

Regardless of the data structure used to associate the assessee shape answer and the feedback object, the grading subsystem and/or the feedback subsystem described in greater detail below can obtain the feedback object given the answer object's data structure.

The grading subsystem provides mechanism to greatly reduce the amount of time and human effort necessary to associate a feedback object with an assessee answer item. In some embodiments, the grading subsystem may facilitate one-at-a-time shape grading, in which an assessor is presented with a shape problem (that may have come from a shape problem authoring subsystem) and one or more shape answer items created or modified by a single assessee. In some embodiments, the assessee shape answer item may be displayed on a digital display in much the same form as the assessee saw their answer in the shape problem administration subsystem. In addition to this presentation of the shape problem and answer items, the assessor may also be presented with a list of one or more feedback objects. The list of feedback objects can be edited interactively by the assessor to add new feedback objects and delete or modify existing ones.

An example of some of these features is described in “A Fast, Flexible, and Fair System for Scalable Assessment of Handwritten Work” presented and published by Arjun Singh, Sergey Karayev, Kevin Gutowski, and Pieter Abbeel in Proceedings of the Fourth ACM Conference on Learning @ Scale (L@S '17), ACM, New York, N.Y. pp. 81-88, 2017 (hereinafter “Singh”), which is hereby incorporated by reference in its entirety.

In one-at-a-time shape grading approaches, the assessor may interactively select a shape answer item from a presentation of one or more answer items and associate one or more feedback objects therewith. The Assessor may interactively specify that the selected feedback object(s) are to be associated with the selected shape answer item(s).

Shape grading can proceed by repeating the above association of answer items with feedback objects for each answer item of each student until completion. This may be marginally more efficient than manually grading on paper because digital feedback objects may be reused; however, the assessor is still required to manually assign feedback to each answer item.

In another embodiment of a grading subsystem, multiple answers from multiple students are presented to the assessor simultaneously. Such an approach may be referred to as a multi-answer presentation approach. In a multi-answer presentation approach, a set of assessee shape answer items may be presented in such a way so as to facilitate batch grading. For example, one approach for multi-answer presentation is to display all of the assessee answer items as an overlay on a given challenge shape problem.

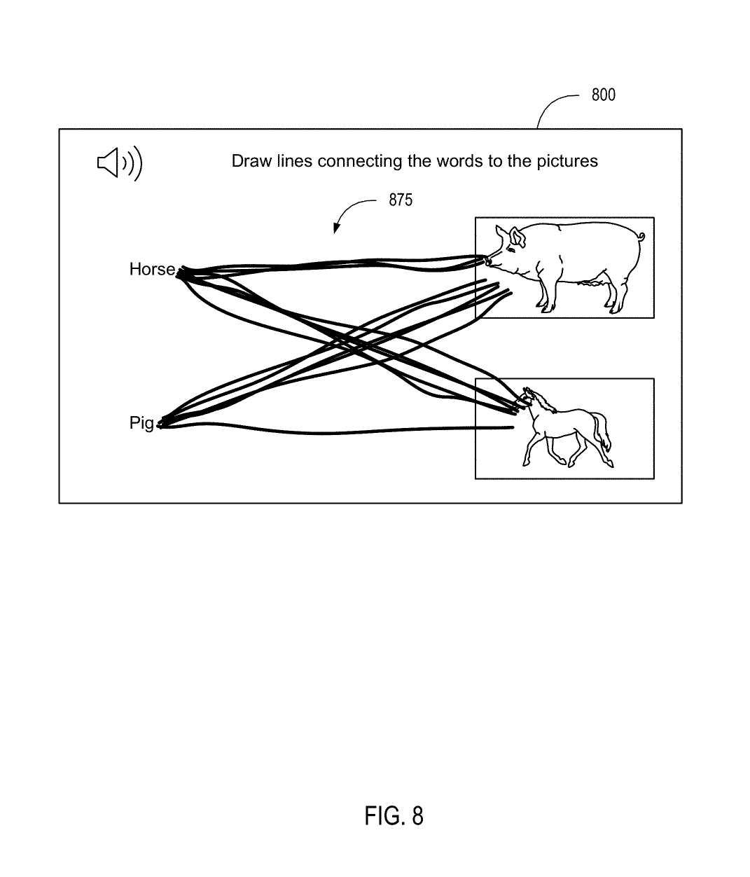

FIG. 8 illustrates an opaque overlay of shape answers 875 in the form of digital ink strokes overlaid on a shape problem 800, according to one embodiment. An opaque overlay of multiple assessee shape answers 875 on a single shape problem 800 cannot be replicated or even remotely approximated by manual grading of paper assessments nor by the one-at-a-time grading approaches described by Singh. A similar approach can be applied to any shape answer created or modified by assessees, not just digital ink strokes.

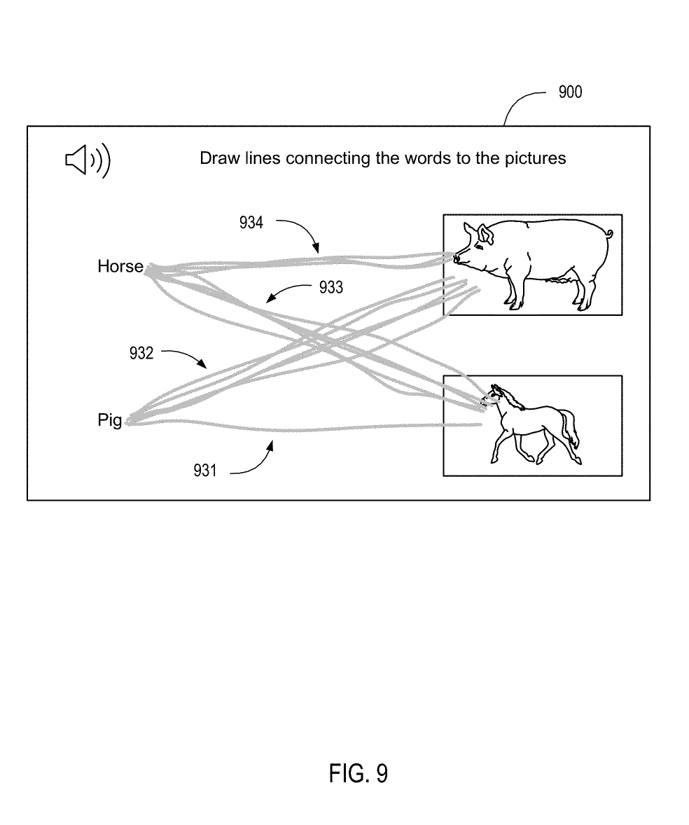

FIG. 9 illustrates an alternative approach in which multiple assess answer items 931-934 are overlaid as semi-transparent geometric shapes (e.g., a digital ink stroke) on a shape problem 900. As described in greater detail below, an assessor may assign feedback to a selected geometric shape. The grading subsystem may automatically assign identical feedback to one or more similar or identical geometric shapes.

In some embodiments, graded geometric shapes may be removed from the display so that the assessor can more easily identify the geometric shapes that have not yet been associated with or assigned a feedback object.

In some embodiments, rather than selecting a digital ink stroke, the assessor may create or modify a geometric shape to serve as a model shape answer item. The assessor may then assign a feedback object to the model shape answer item. Assessee shape answer items that are identical to or similar to the model shape answer item may be automatically associated with a similar feedback object.

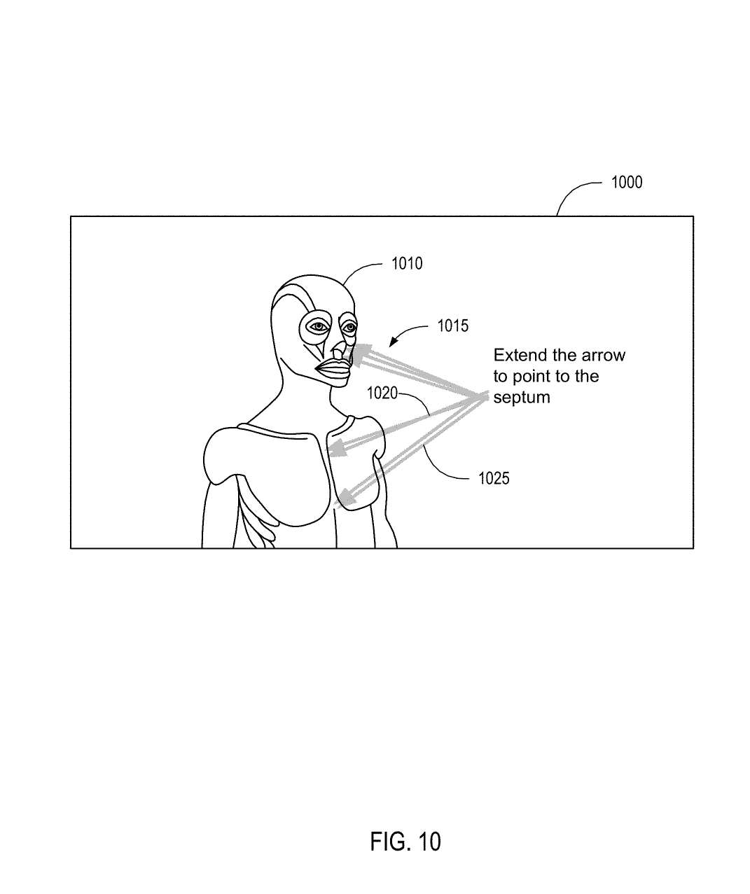

FIG. 10 illustrates partially transparent shape answers 1015, 1020, and 1025 from multiple assessees in the form of modifiable shapes overlaid as semi-transparent objects on a shape problem 1000, according to one embodiment. In this embodiment, only the endpoint of the modifiable geometric shape (i.e., the tip of the arrow) is relevant to the answer. Accordingly, in some embodiments, an assessor may create a rectangle around the septum of human body and indicate that any assessee answer item that has an endpoint of the arrow contained with the rectangle is to be associated with certain positive feedback. All of the assessee answer items that have an endpoint of the arrow that is not contained within the rectangle may be associated with certain negative feedback.

Alternatively or additionally, FIG. 10 may be graded by an assessor via the selection of one of the modified geometric shapes and assignment of a feedback object thereto. Similarly, FIG. 10 may be alternatively or additionally graded by the assessor creating or modifying a geometric shape to form a model answer item for similarity comparison.

In some embodiments, as an assessor creates a model geometric shape for multiple-answer grading, all of the assessee answer items that would be affected are highlighted, bolded, or otherwise emphasized to facilitate accurate batch grading. For instance, as the assessor creates a model digital ink stroke, those digital ink strokes that would be considered identical or similar may be visually emphasized so that the assessor can visually see the impact of the batch grading. Similarly, as the size of a rectangle drawn by the assessor increases, a larger number of assessee answer items may be affected and therefor emphasized. The assessor can slowly enlarge and/or reposition the rectangle to ensure that it affects the desired set of assessee answer items.

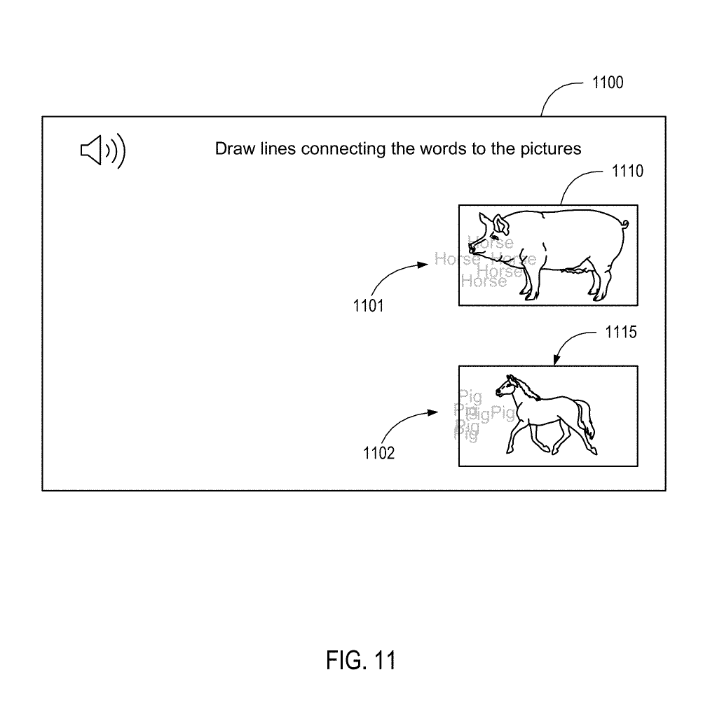

FIG. 11 illustrates partially transparent shape answers 1101 and 1102 from multiple assessees in the form of moveable shapes overlaid on a shape problem 1100, according to one embodiment. As illustrated, the partial transparency helps to prevent the underlying shape problem 1100 from being completely obscured. Specifically, the images of the pig 1110 and the horse 1115 are still visible through the partially transparent assessee shape answers.

In yet another embodiment, the grading subsystem may sample a set of assessee shape answer items and display only a sample of each set. Accordingly, a single assessee shape answer item may be displayed that represents all assessee shape answer items that are considered identical or sufficiently similar to be automatically associated with the same feedback object. Such an approach may reduce the number of shapes presented to the assessor, while still giving the assessor a sense of the set of shapes in the assessee's answers.

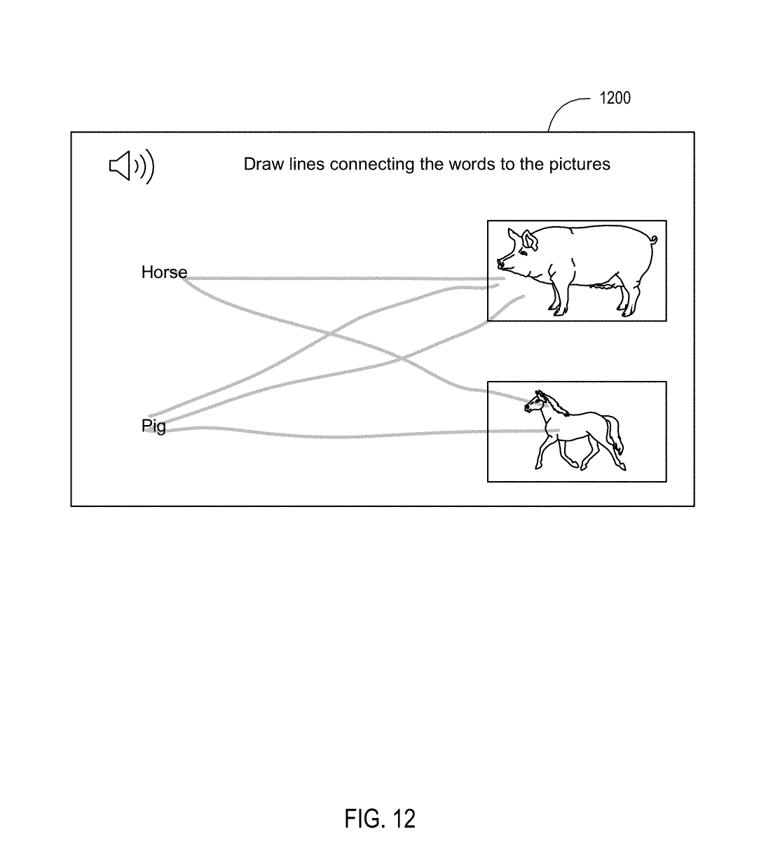

FIG. 12 illustrates an example 1200 of such a sub-sampled overlay of shape answers from multiple assessees for assessment by an assessor, according to one embodiment. Hundreds of assessee answer items may be sub-sampled to identify a few displayable shape answer items that are representative of the multiple assessee answer items.

In one embodiment, the grading subsystem may generate a sub-sampled presentation by randomly selecting shapes from the assessee's answer items. In an alternatively approach, the grading subsystem may generate a sub-sampled presentation by first dividing the set of shape answers into clusters using a clustering algorithm. A clustering algorithm may use a similarity function on feature-vector representations of shapes to divide the shapes into K subsets (clusters) of the original set of shape answer items. The shapes in a given cluster are more similar to each other than they are similar to shapes in other clusters. One such clustering algorithm is K-means clustering described in Duda. Another such algorithm is agglomerative clustering, also described in Duda.

Once the shapes are clustered, the grading subsystem may present a random sample from each cluster. The assessor may then select each of the clusters in turn for grading (e.g., association of a feedback object). As described above, given a set of shape answer items presented in a multi-answer presentation, an assessor can interactively select one or more of the feedback objects in the feedback list and interactively associate the selected feedback objects with all of the shapes in the multi-answer presentation.

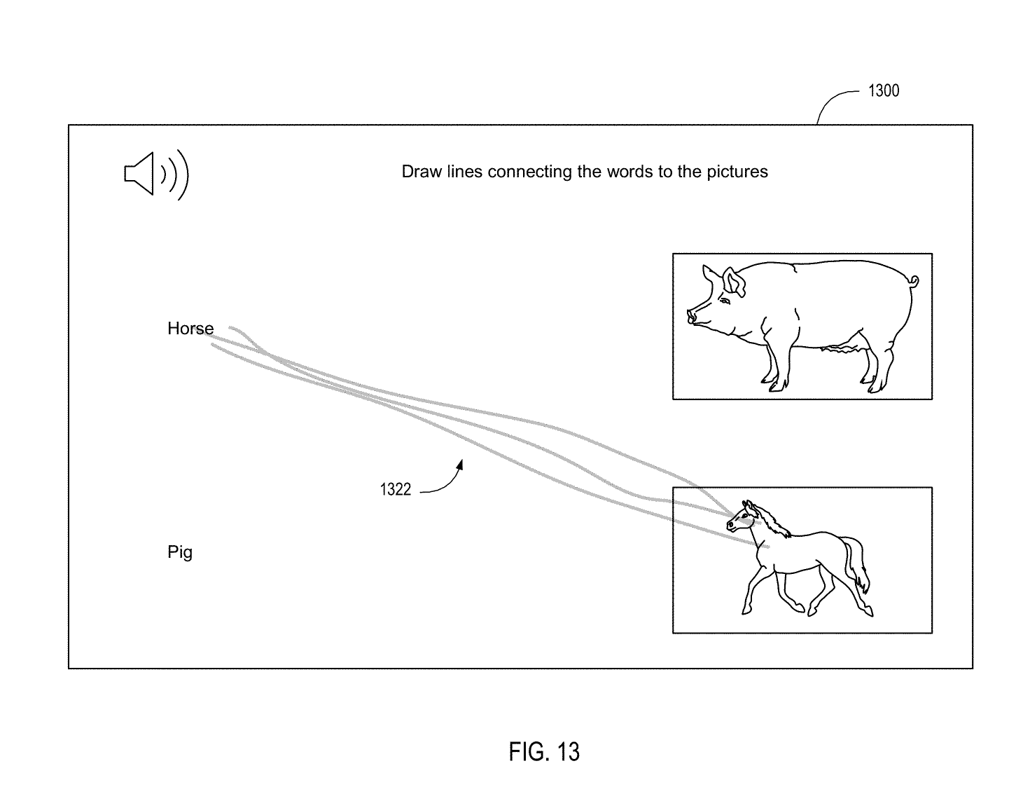

FIG. 13 illustrates a group of shape answers 1322 to a shape problem 1300 from multiple assessees that can be batch-assessed by an assessor, according to one embodiment. The clear advantage of batch shape grading is that the assessor is able to assign feedback to multiple assessee answer items simultaneously. This is significantly faster than any paper-based grading method or the one-at-a-time approach described above. In the case of sub-sampled presentations, the assessor is potentially grading many student answer items that they do not even see. This provides a significant labor advantage. The efficiencies and advantages of such an approach can be better appreciated in the context of “Interactive Machine Learning” by Jerry Alan Fails and Dan R. Olsen in Proceedings of the 8^{Th} International Conference on Intelligent User Interfaces, ACM, New York, N.Y., pp. 39-45, 2003 (hereinafter “Fails”), which is hereby incorporated by reference in its entirety.

For some assessors, decomposing a set of assessee shape answer items into smaller sets may not be as natural as it is to computer programmers. Accordingly, in some embodiments the grading subsystem may implement multi-shape rule grading based on shape rules. A shape rule may include of one or more shape predicates, each shape predicate may include a shape and a geometric relation. One way to interpret a shape rule is according to the following:

```
RuleMatch(shapeRule, shape)=>Boolean {
    Foreach shape predicate S in shapeRule {
        If ( not S.relation(S,shape) ) {
            Return false;
        }
    }
    Return true;
}
```

Accordingly, each shape rule may be associated one or more feedback objects. The assessor can create a shape rule by drawing shape predicates with associated shapes and relations onto a multi-answer presentation and then interactively associate one or more feedback objects with that rule.

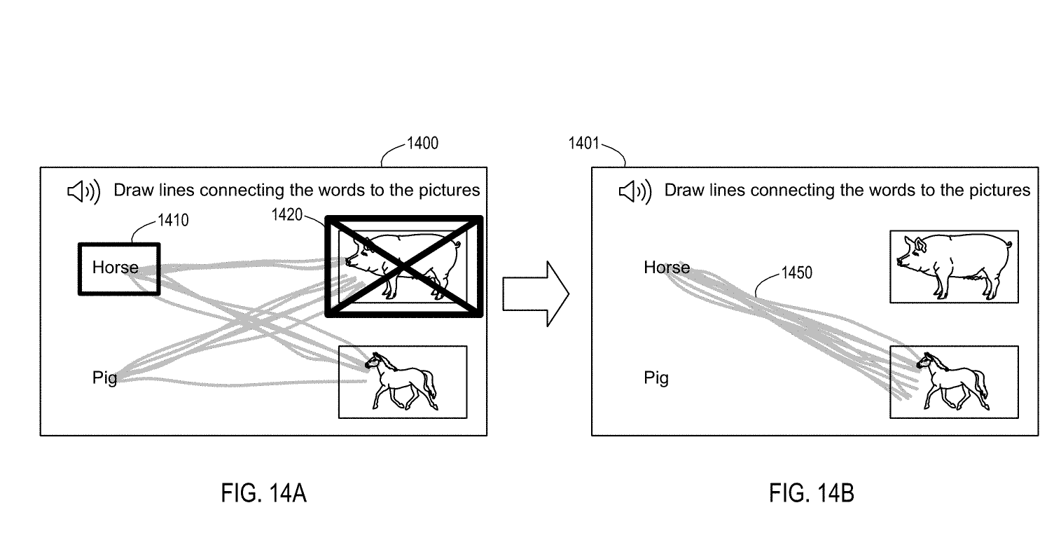

FIG. 14A illustrates a shape rule creation by an assessor using rectangular shape predicates for batch-assessment, according to one embodiment. In the illustrated embodiment, the two shape predicates are rectangles 1410 and 1420. The left rectangular shape predicate 1410 has the Touches relation associated with it. The right rectangular shape predicate 1420 (with the cross) has the ˜Touches or ˜contains relation associated with it.

By drawing these two shape predicates 1410 and 1420 over the multi-answer presentation 1400, the assessor has selected the set 1450 of assessee shape answer items that touch the rectangular shape predicate 1410 and do not touch (or are not contained within) the rectangular shape predicate 1420 with the cross. The matching answer shapes 1450 are shown in the modified multi-answer presentation 1401 in FIG. 14B. This cluster of matching answer shapes 1450 can now be batch graded by associating one or more feedback objects with the cluster of matching shapes 1450 selected by the rules defined by rectangular shape predicates 1410 and 1420.

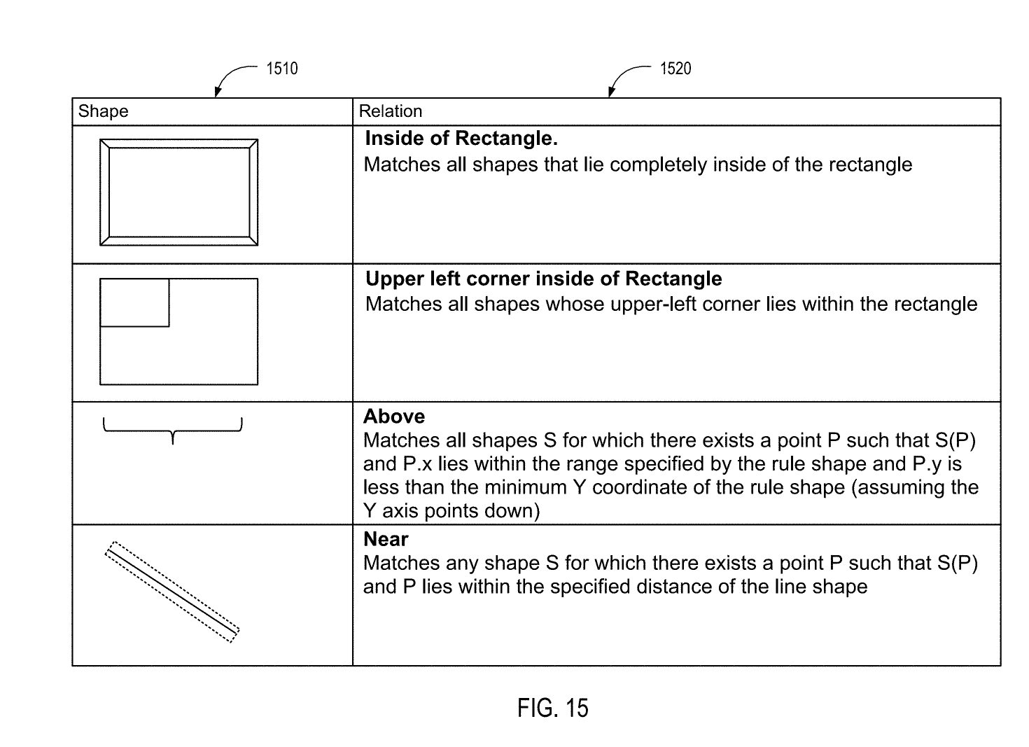

FIG. 15 illustrates a table of example shapes predicates 1510 and associated relations 1520 for batch-assessment, according to one embodiment. A wide variety of shapes and relations are possible in one, two, three, or more dimensions.

In some embodiments, an assessor can create multiple shape rules and relations, each of which may be associated with a feedback object. Such a set of shape rules can automatically grade a large number of shape answer items. In one embodiment, a grading subsystem implements an algorithm for interpreting a set of shape rules is as follows: where each answer shape A can have one or more feedback items designated A.feedback and every shape rule R can have one or more feedback items designated R.feedbackObjects. This can be expressed as:

ShapeRuleSet=the set of all shape rules created for a given shape problem;

AnswerShapeSet=the set of all shapes created by students to answer the shape problem;

```
Foreach Shape A in AnswerShapeSet{
    A.feedback = empty;
}
Foreach Shape A in AnswerShapeSet {
    Foreach ShapeRule R in ShapeRuleSet {
        If (RuleMatch(R,A) ){
            Add R.feedbackObjects to A.feedback;
        }
    }
}
```

In some embodiments, an answer shape A may have zero feedback items and/or a shape rule R may have zero feedback items.

A user interface of the grading subsystem can assist the assessor by not displaying any assessee shape answer items that already match a previously created shape rule and/or have been otherwise associated with a feedback object. This will enable the assessor to better understand which assessee answer items still need to be graded. For example, after creating the rule in FIG. 14 the shape problem grading system could display the cluster of shapes that still need to be graded.

Because many shapes (i.e., those that have already been graded) may be removed from the displayed assessee shape answer items, the assessor might mistakenly create a rule that is too general. Thus, in some embodiments, new rules may only be applied to those assessee shape answer items that are being displayed. In other embodiments, any assessee answer item that matches the newly created rule may be added back to the display to clearly show the assessor the effects of the grading rule being created. These two sets of shapes (those that are displayed and affected, and those that were previously removed from the display but are now being affected) can be distinguished by drawing them in different styles, such as levels of transparency, color, fill, and/or line style.

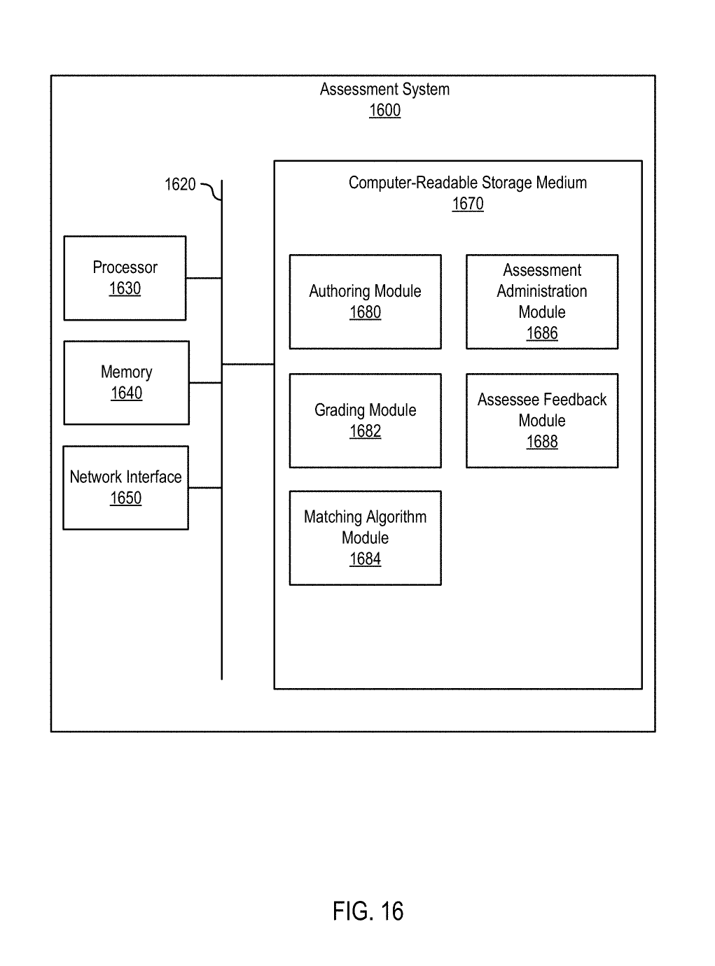

FIG. 16 illustrates a functional block diagram of one embodiment of an assessment system to implement one or more embodiments and subsystems described herein. As illustrated, an assessment system 1700 may include a processor 1730, memory 1740, and a network interface 1750 that are connected to a non-transitory computer-readable storage medium 1770 via a bus 1720. The non-transitory computer-readable storage medium 1770 may be replaced interchangeable by any combination of hardware, firmware, and software.

As illustrated, the non-transitory computer-readable storage medium 1770 includes an authoring module 1780 to implement the features and functions described herein in conjunction with the authoring subsystem. A grading module 1782 may implement the features and functions described herein in conjunction with the grading subsystem. A matching algorithm module 1784 may implement the features and functions described herein relating to determining similarity and rules.

An assessment administration module 1786 may implement the features and functions described herein in conjunction with the administration subsystem. The Assessee feedback module 1788 may implement the features and functions described herein relating to associating feedback objects with assessee answer items.

This disclosure has been made with reference to various exemplary embodiments, including the best mode. However, those skilled in the art will recognize that changes and modifications may be made to the exemplary embodiments without departing from the scope of the present disclosure. While the principles of this disclosure have been shown in various embodiments, many modifications of structure, arrangements, proportions, elements, materials, and components may be adapted for a specific environment and/or operating requirements without departing from the principles and scope of this disclosure. These and other changes or modifications are intended to be included within the scope of the present disclosure.

This disclosure is to be regarded in an illustrative rather than a restrictive sense, and all such modifications are intended to be included within the scope thereof. Likewise, benefits, other advantages, and solutions to problems have been described above with regard to various embodiments. However, benefits, advantages, solutions to problems, and any element(s) that may cause any benefit, advantage, or solution to occur or become more pronounced are not to be construed as a critical, required, or essential feature or element.

What is claimed is:

1. An assessment system for grading assessments, comprising:
at least one electronic display;
at least one electronic input device;
at least one computing device, each computing device in communication with at least one of the at least one electronic displays and at least one of the at least one electronic input device, each computing device configured to implement at least one of a plurality of modules, comprising:
an authoring module to allow an author to create a plurality of challenge problems, wherein each challenge problem can each be electronically displayed to each of a plurality of assessees and answered by each assessee by one of:
creating a geometric shape to form a geometric shape answer item relative to a displayed challenge problem, and
modifying a geometric shape to form a geometric shape answer item relative to a displayed challenge problem;
an administration module to display each challenge problem to each of the plurality of assesses and receive geometric shape answer items formed by each assessee relative to each displayed challenge problem;
a grading module to:
display a challenge problem to an assessor concurrently with a plurality of geometric shape answer items formed by multiple assessees relative to the displayed challenge problem, and
receive a feedback object from the assessor and associate the feedback object with at least some of the displayed plurality of geometric shape answer items based on at least one of:
an assessor selection of multiple geometric shape answer items,
a model shape answer item formed by the assessor that selects multiple geometric shape answer items based on similarity, and
a shape rule created by the assessor that includes at least one geometric shape formed by the assessor and an associated relation rule that selects multiple geometric shape answer items.

2. The assessment system of claim 1, wherein the author and the assessor are the same entity.

3. The assessment system of claim 1, wherein the feedback object is associated with at least some of the plurality of geometric shape answer items based on an assessor selection of multiple geometric shape answer items.

4. The assessment system of claim 1, wherein the feedback object is associated with at least some of the plurality of geometric shape answer items based on a model shape answer item formed by the assessor that selects multiple geometric shape answer items based on a determined similarity between the model shape answer item and each selected geometric shape answer item.

5. The assessment system of claim 1, wherein the feedback object is associated with at least some of the plurality of geometric shape answer items based on a shape rule created by the assessor that includes at least one geometric shape formed by the assessor and an associated relation rule that selects multiple geometric shape answer items.

6. A method of grading an electronically administered assessment, comprising:
displaying, via an electronic display, a set of geometric shape answer items created by a plurality of assessees relative to a challenge problem;
receiving, via an electronic input device, a first grading shape predicate from an assessor, wherein the first grading shape predicate comprises:
a predicate geometric shape formed by the assessor relative to the challenge problem, and
an associated predicate relation rule that defines a selection of a subset of the set of geometric shape answer items based on the predicate geometric shape formed by the assessor;
receiving, from the assessor, a first feedback object to be associated with the subset of the set of geometric shape answer items that is selected by the first grading shape predicate; and
associating the first feedback object with each of the geometric shape answer items in the subset of the set of geometric shape answer items.

7. The method of claim 6, wherein receiving the first grading shape predicate from an assessor comprises receiving an assessor selection of at least one of a plurality of predefined grading shape predicates.

8. The method of claim 6, wherein, prior to receiving the first feedback object from the assessor, the subset of the set of geometric shape answer items that is selected by the first grading shape predicate are displayed in a different style than the geometric shape answer items that are not selected by the first grading shape predicate.

9. The method of claim 8, wherein the subset of the set of geometric shape answer items that is selected by the first grading shape predicate are displayed as opaque overlays on the challenge problem and the geometric shape answer items that are not selected by the first grading shape predicate are displayed as semi-transparent overlays on the challenge problem.

10. The method of claim 6, further comprising:
removing from the overlaid display of geometric shape answer items all of the geometric shape answer items that are associated with the first feedback object, such that only those geometric shape answer items of the set of geometric shape answer items that have not yet been associated with at least one feedback object (the remaining geometric shape answer items) are displayed in the overlay on the challenge problem.

11. The method of claim 10, further comprising:
receiving, from the assessor, a second grading shape predicate that selects a subset of the remaining geometric shape answer items;
receiving, from the assessor, a second feedback object to be associated with the subset of the remaining geometric shape answer items; and
associating the second feedback object with each of the geometric shape answer items in the subset of the remaining geometric shape answer items.

12. The method of claim 6, wherein the set of geometric shape answer items are displayed as one or more overlays on the challenge problem.

13. The method of claim 12, wherein each of the set of geometric shape answer items are displayed as a semi-transparent overlay on the challenge problem.

14. The method of claim 12, wherein a sampled subset of geometric shape answer items is displayed as an overlay on the challenge problem.

15. The method of claim 6, wherein at least one of the geometric shape answer items is formed by a draggable object being moved by an assessee from a first location relative to the challenge problem to a second location relative to the challenge problem.

16. The method of claim 6, wherein each of the geometric shape answer items comprises a modifiable geometric shape that has been modified from an original shape to a modified shape relative to the challenge problem.

17. A system, comprising:
a processor;
an electronic display in communication with the processor; and
a non-transitory computer readable medium comprising instructions that, when executed by the processor, cause the processor to implement operations for grading an electronically administered assessment, the operations comprising:
displaying, via the electronic display, a set of geometric shape answer items created by a plurality of assessees relative to a challenge problem;
receiving, via an electronic input device, a first grading shape predicate that includes:
a predicate geometric shape formed relative to the challenge problem, and
an associated predicate relation rule that defines a selection of a subset of the set of geometric shape answer items based on the predicate geometric shape;
receiving a first feedback object to be associated with the subset of the set of geometric shape answer items that is selected by the first grading shape predicate; and
associating the first feedback object with each of the geometric shape answer items in the subset of the set of geometric shape answer items.

18. The system of claim 17, wherein receiving the first grading shape predicate from an assessor comprises receiving an assessor selection of at least one of a plurality of predefined grading shape predicates.

19. The system of claim 18, wherein, prior to receiving the first feedback object from the assessor, the subset of the set of geometric shape answer items that is selected by the first grading shape predicate are displayed in a different style than the geometric shape answer items that are not selected by the first grading shape predicate.

20. The system of claim 19, wherein the subset of the set of geometric shape answer items that is selected by the first grading shape predicate are displayed as opaque overlays on the challenge problem and the geometric shape answer items that are not selected by the first grading shape predicate are displayed as semi-transparent overlays on the challenge problem.
